(19) United States
(12) Patent Application Publication
(10) Pub. No.: US 2008/0282919 A1
(43) Pub. Date: Nov. 20, 2008

(54) Clamping Device

(76) Inventor: Wolfgang Dennstedt, Bern (CH)

Correspondence Address: RATNERPRESTIA, P O BOX 980, VALLEY FORGE, PA, 19482-0980, US

(21) Appl. No.: 11/596,033

(22) PCT Filed: May 10, 2005
(86) PCT No.: PCT/EP05/05045

§ 371 Date: Sep. 14, 2007

(30) Foreign Application Priority Data
May 10, 2004 (DE) 10 2004 023 008.0

(51) Int. Cl. B41F 1/28

(52) U.S. Cl. 101/409

(57) ABSTRACT

A printing cylinder, including: a cylinder body defining at least one tensing channel for tensing with at least one printing block; a tensing jaw arranged in the tensing channel; and a tensing counter jaw which is arranged next to the tensing jaw in the tensing channel and is tiltable about a rotational axis relative to the tensing jaw and the cylinder body, and comprises a tilting area on an outer circumferential area; wherein the tensing jaw and the tensing counter jaw define at least a portion of a gap, into which one end of the at least one printing block can be inserted; and wherein the tensing counter jaw is supported during a tilting movement via its tilting area on a supporting area formed in the tensing channel.

This application is the U.S. national phase application of PCT International Application No. PCT/EP2005/005045, filed May 10, 2005, which claims priority to German Patent Application No. DE 10 2004 023 434.5, filed May 10, 2004.

### BACKGROUND OF THE INVENTION

1. Technical Field

The invention relates to a tensing means incorporated in a printing cylinder of a rotary printing machine.

2. Description of the Related Art

Tensing means serve to tense one or more printing blocks or another cylinder film, for example a rubber blanket, on a cylinder of a rotary printing machine. For this purpose, the cylinder in question is provided with at least one tensing channel which extends axially on the surface of the cylinder and in which the tensing means is arranged. Typical tensing means comprise tensing jaws which are movable in the tensing channel and form, with each other or with an opposite wall of the tensing channel, a clamping gap for one end of a cylinder film. Such tensing means are known for example from DE 100 03 937 A1, U.S. Pat. No. 4,421,024 and DE 2 220 652 A. In accordance with the latter document, two pairs of tensing jaws are arranged next to each other in the tensing channel and mounted as concentric shafts nested in each other, each one as a hollow shaft, and such that they are rotatable relative to each other. This tensing means is complex and requires a lot of space.

Tensing means should be compact so that the tensing channel accommodating the tensing means can be as small, in particular narrow in the circumferential direction, as possible. Furthermore, the tensing channel should be shaped as simply as possible.

Roller rotary printing machines, such as the invention also relates to in particular, are generally fitted with printing block cylinders which are several sides wide, wherein multiple printing blocks are tensed axially next to each other on the surface of said printing block cylinders. In a printing tower comprising for example four printing unit bridges arranged on top of each other for the primary and secondary printing of for example four colours, the width of the continuous web changes from printing gap to printing gap, in particular in wet offset printing. This phenomenon of width variation, known in particular in wet offset printing as “fan-out”, requires an adapted variation of the axial offset of the printing blocks from printing unit bridge to printing unit bridge. This is usually set by the manufacturer of the machine and, as applicable, also later readjusted on site. This problem can occur not only in rotary printing machines having a tower construction, but also in other types of installation. Register means are known for setting the axial offset of the printing blocks of a printing block cylinder with respect to each other. These are usually set manually for each printing block.

The constant push to reduce the so-called channel kick means that the opening of the tensing channel is becoming ever narrower in the circumferential direction and the tensing channel is also becoming ever smaller. The tensing channels are now so small that a tensing channel can extend over the entire axial width of a printing block cylinder. Arranging the tensing means and also the register means for the clamping and setting of the axial position which are individual for each printing block cylinder are particularly problematic in a small tensing channel. However, this also applies in a weakened form to the previously typical, larger tensing channels.

### SUMMARY OF THE INVENTION

It is an object of the invention to reduce the space requirement for a tensing means of a printing cylinder which serves to clamp one end of a printing film.

The tensing means should be simple to assemble. It is also advantageous if the tensing means is only composed of a few parts, in particular only composed of a few parts which are movable relative to each other.

In accordance with another aspect, the space requirement for a register means which serves to set the axial offset of a printing film should be reduced. Another object is to make it easier to assemble such a register means.

For the printing film, the tensing means comprises at least two, preferably exactly two tensing jaws which form at least one gap in the tensing channel into which one end of a colour-transferring printing film can be inserted and held during printing operations. The gap can be provided for accommodating two film ends lying on each other. More preferably, however, the tensing jaws in the tensing channel form two gaps into each of which one end of the same film or one end of a first film and one end of a second film sequential to the first film along the circumference of the cylinder can be inserted and held during printing operations. The gap, one of the two gaps, or both gaps can be formed as a clamping gap. If two gaps are formed in the tensing channel, however, then it is preferable if one of the two gaps is formed as a fixed pocket which no longer changes during printing operations. This makes it easier to insert and remove a film end, which is advantageously angled, into and from the gap in question.

At least one of the tensing jaws is movable relative to the cylinder and to the other tensing jaw. For the purpose of differentiating terms, the movable tensing jaw shall be referred to as the tensing counter jaw, which does not however mean that it has to form a gap for a film end with the other tensing jaw.

In accordance with the invention, the tensing counter jaw is arranged next to the tensing jaw, i.e. the tensing jaw and the tensing counter jaw extend longitudinally next to each other and not surrounding each other. The tensing counter jaw is rotatable, relative to the tensing jaw and relative to the cylinder, about a rotational axis parallel to the rotational axis of the cylinder. The rotational movement is a tilting movement in which the tensing counter jaw can tilt back and forth about the rotational axis, in order to be able to insert the end of the printing film into a gap which the tensing counter jaw forms with the tensing jaw or with a facing wall of the tensing channel. An outer circumference of the tensing counter jaw comprises a tilting area and is supported during its tilting movement via its tilting area on a supporting area formed in the tensing channel, preferably by pressing loosely against the supporting area. An advantageously linear contact point at which the tensing counter jaw contacts the supporting area forms the rotational axis of the tensing counter jaw. For rotationally mounting, a tensing channel can advantageously form a round, preferably cylindrical rotational mounting area in the manner of a bearing eye, on which the tensing counter jaw slides off with a congruently shaped mounting counter area. The tensing channel preferably forms the rotational mounting area in the base of the channel and with a side wall merging into the base of the channel beyond the rotational mounting area. The compactness of the tensing means is benefited if—when the tensing counter jaw is rotatable, i.e. tiltable, as is preferred—the tensing counter jaw slides or/and rolls off directly on the tensing jaw, i.e. if it is arranged between the rotational mounting area mentioned and the tensing jaw, contacting both, preferably clamped. The rotational mounting area and the mounting counter area of the tensing counter jaw are preferably shaped such that a rotational bearing is formed for the tensing counter jaw, with the rotational axis as a fixed rotational axis. In principle, however, it would also be possible for the rotational axis or tilting axis of the tensing counter jaw to not be set stationary in the tensing channel but rather variable within the context of the possible tilting movement. A cantilever as described above between the rotational mounting area and the supporting area of the tensing counter jaw increases the rigidity of the tensing means and reduces the space requirement.

The tensing counter jaw preferably has the shape of a divided shaft, i.e. a segmented shaft, the division area of which—which is intended as an intersection area—forms a tilting area on which the tensing counter jaw is supported on the facing supporting area during its tilting movement. Advantageously, the tensing jaw directly forms this supporting area. In principle, however, the supporting area can also be formed in other ways in the tensing channel, for example by a separate supporting element. However, forming the supporting area directly on an outer circumferential area of the tensing jaw benefits the compactness of the tensing means. The term “intersection area” of “division area” is not intended to mean that the tensing counter jaw is initially manufactured as a solid shaft and then obtains the shape of a segmented shaft using a suitable separating method, although this does represent one way of manufacturing the tensing counter jaw. The tensing counter jaw can also be perfectly well manufactured directly, in an original moulding method, in the shape of a segmented shaft.

The tensing jaw advantageously exhibits the shape of a divided shaft, i.e. a segmented shaft, wherein that which has been said above with respect to the tensing counter jaw is intended to apply to the tensing jaw. If, as is preferred, both the tensing jaw and the tensing counter jaw each exhibit the shape of a segmented shaft, then in preferred embodiments they are arranged next to each other such that they contact each other via their division areas and collectively as a unit have the shape of a complete shaft. It is particularly advantageous if the complete shaft is tapered from a segment cross-section, preferably a circular segment cross-section arranged towards the base of the tensing channel, towards an opening of the tensing channel. A tensing means which is composed of segmented shafts contacting each other, is particularly compact in its cross-section and accordingly requires little space.

In one preferred embodiment, a spring means which ensures that the tensing counter jaw is pressed against a clamping counter area by a clamping force, even when the cylinder is idle, is supported on the tensing jaw and on the tensing counter jaw, i.e. the spring means is incorporated between the tensing jaw and the tensing counter jaw. The spring force preferably acts on the tensing counter jaw tangentially with respect to the rotational axis of the cylinder.

The tensing jaw can be fixed in the tensing channel, such that it cannot perform any movements relative to the cylinder in a direction transverse to the rotational axis of the cylinder. The fixed tensing jaw can in particular form the invariable gap mentioned with a channel wall facing opposite.

The tensing channel preferably serves to attach multiple printing films, for example printing blocks, which are arranged axially next to each other. The multiple films can advantageously be attached separately by means of the tensing means. The tensing jaw preferably extends in one piece or as a constructed shaft over the collective axial length of multiple printing films, preferably over the axial length of the tensing channel. Tensing counter jaws are preferably provided in numbers which correspond exactly to the number of cylinder films which can be attached in the tensing channel. A number of the movable tensing counter jaws can also be provided, as applicable, for each cylinder film. The statements made in connection with an individual tensing counterjaw advantageously apply to each of the tensing counterjaws.

In preferred embodiments, a register means for setting an axial offset of printing films of the printing cylinder is not mounted on the printing cylinder separately from the tensing means for tensing the same printing film but is rather mounted by the tensing means. The tensing means and the register means are combined in an integrated tensing and register means. It is particularly advantageous if the tensing means and the register means form a unit which is assembled before being incorporated into a tensing channel and thus is or can be inserted into the tensing channel as an assembly unit or at least as a joining unit which is simple to insert. In a preferred embodiment, the pre-assembled joining unit—comprising the tensing jaw, the tensing counter jaw or multiple tensing counter jaws and the register means—is inserted into the tensing channel from the end-facing side of the printing cylinder and can also be withdrawn from the tensing channel again towards the end-facing side. For a tensing and register means incorporated in this way, a filling piece which is inserted into a groove formed on the circumference of the cylinder together with a conventional tensing and register means can be omitted. The tensing channel can be provided directly on the cylinder, in its final shape comprising a narrow opening. This is met by a smooth, circular surface right up to the edges which define the channel opening on both sides.

Preferably, the tensing jaw and the tensing counter jaw contact each other only loosely, thus forming a particularly simple joint between the two. Advantageously, the spring or multiple springs is/are also accommodated only loosely, i.e. not screwed in or otherwise attached.

It is advantageous if the tensing jaw, in particular the tensing jaw fixed in the tensing channel, mounts the register means. The mounting is preferably formed as a slide mounting, the sliding areas of which extend parallel to the rotational axis of the cylinder.

In a preferred embodiment, the register means comprises an axially adjustable register member and an adjusting member for each printing block. The register member is in register engagement with a printing film, causing the printing film to be slaved in an axial movement of the register member. The adjusting member is connected in a joint to each of the tensing means, preferably the tensing jaw, and the register member. The two joints are preferably formed by only two joint elements each, wherein the adjusting member and the tensing means form the two joint elements in one joint, and the adjusting member and the register member form the two joint elements in the other joint. Such a register means can advantageously consists of very few parts, namely the register member, the adjusting member and the tensing means serving as a bearing member, wherein one or more mounting areas, advantageously formed by the wall of the tensing channel, are not included. If, as is preferred, multiple printing films can be attached in the tensing channel, then a corresponding number of register means are arranged in the tensing channel, preferably exactly one register means for each printing film.

The supporting area of the register member, advantageously formed as a sliding area by the tensing means, advantageously opposes the channel opening, facing radially. The register means can then be constructed particularly short in the radial direction, radially with respect to the rotational axis of the cylinder. Previously, register means have usually been supported on the base of the tensing channel, such that they have to extend over almost the entire depth of the tensing channel in order to provide the engagement with the end of the printing block which is required for adjusting.

The printing films can in particular be printing plates, and the printing cylinder or cylinders can correspondingly be plate cylinders for offset, wet offset or dry offset.

### BRIEF DESCRIPTION OF THE DRAWINGS

An example embodiment of the invention is explained below on the basis of figures. Features disclosed by the example embodiment, each individually and in any combination of features, advantageously develop the subjects of the claims and the embodiments described above. There is shown:

FIG. 1 is a perspective view of a pre-assembled tensing and register means;

FIG. 2 is a cross-sectional view of a tensing channel with the tensing and register means incorporated taken along the line A-A in FIG. 1;

FIG. 3 is a cross-sectional view of the tensing channel with the tensing and register means taken along the line B-B in FIG. 1; and

FIG. 4 is a cross-sectional view illustrating a joint of the register means.

### DETAILED DESCRIPTION

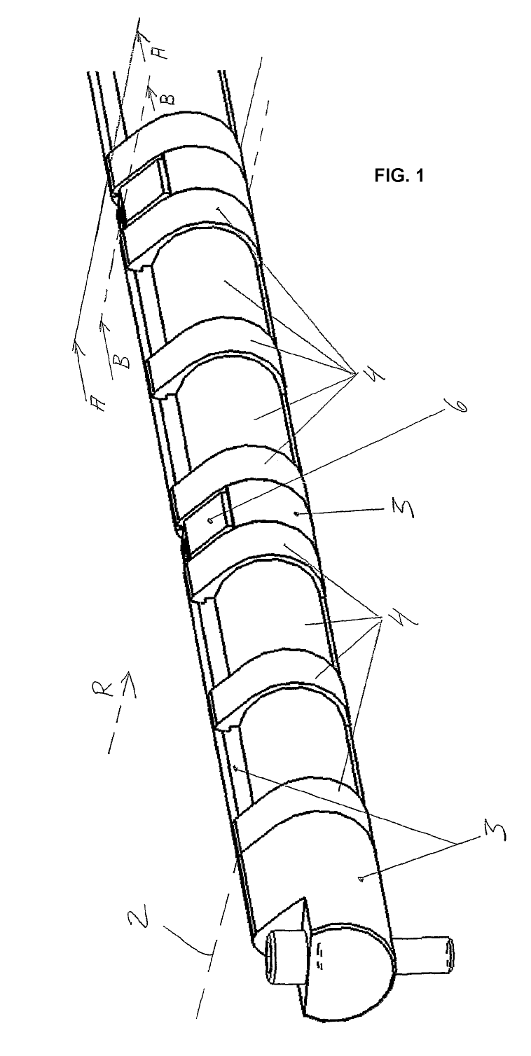

FIG. 1 shows a perspective representation of a pre-assembled tensing and register means. The tensing means consists of a shaft-shaped, elongated tensing jaw 3 and multiple tensing counter jaws 4 arranged next to each other at short intervals along the tensing jaw 3. Register members 6 in the form of register cams are arranged on the tensing jaw 3 between each two tensing counter jaws 4, i.e. exactly one register member 6 between two tensing counter jaws 4 narrowly spaced to the left and right of the register member 6 in question. The tensing jaw 3 forms first axial sections which are identical to each other and in which the tensing counter jaws 4 are arranged, and second axial sections which are identical to each other and in which the register members 6 are arranged, in an alternating sequence. The first axial sections are significantly longer than the second axial sections. Each of the two types of axial section have the shape of a longitudinally divided shaft section. The division of each second axial section is preferably phase-offset by 90° relative to the division of each first axial section, with respect to the longitudinal axis of the tensing jaw 3. The first and second axial sections together form a tensing jaw 3 which is rigid in its own right and can thus be produced in one piece or as a constructed shaft, i.e. produced from axial sections which are placed against each other and rigidly connected to each other.

The tensing counter jaws 4 are likewise each shaped as partial shafts. Each of the tensing counter jaws 4 forms multiple clamping gaps with the tensing jaw 3. In order to form the multiple clamping gaps for each tensing counter jaw 4, the tensing counter jaws 4 are slightly retracted between their axial sections forming the clamping gaps and, in the retracted axial sections, do not contact a clamping area of the tensing jaw 3 forming the clamping gap.

The register members 6 are mounted such that they can slide axially back and forth in the second axial sections of the tensing jaw 3. However, they are secured against axial movements relative to the tensing jaw 3 in any axial position which they can assume relative to the tensing jaw 3, i.e. they are fixed in the respective axial position, preferably in a frictional lock, as applicable also in a positive lock.

The tensing and register means forms a joining unit. When inserted into the tensing channel, the tensing counter jaws 4 are held on the tensing jaw 3, by hand or by means of tools, in the state shown which they also subsequently retain in the channel. The register members 6 lie on the tensing jaw 3.

The tensing and register means serves to clamp with respect to the combination of the tensing jaw 3 and the tensing counter jaws 4, and with respect to the combination of the tensing jaw 3 and the register members 6, serves to set the axial positions of multiple printing blocks 2 which are or are to be clamped onto a printing block cylinder fitted with the tensing and register means. Two tensing counter jaws 4 and an engaging register member 6 are provided for each printing block 2 of normal width. For setting the axial positions of the printing blocks 2, the register members 6 each interlock with a cavity at an end of the respective printing block 2 which engages with the tensing channel, such that setting the axial positions of the register members 6 simultaneously also defines the axial positions of printing block 2 engaging with the tensing channel in question, relative to the printing block cylinder and relative to each other. Setting the axial positions of the printing blocks 2 serves to adapt to a width variation of a web to be printed and is used in particular in wet offset roller rotary printing, in order to compensate for the variation in web width between printing gaps sequential to each other in the path of the printing web, which in wet offset roller rotary printing is primarily due to so-called fan-out.

The tensing and register means extends over the entire length of the printing block cylinder which can be tensed with printing blocks 2. In a printing block cylinder which is two, four or six sides wide, it thus serves for tensing and setting the axial positions of a corresponding number of printing blocks 2 which are tensed or are to be tensed onto the printing block cylinder next to each other. The tensing and register means can however also for example only comprise a length for tensing and setting half the number of printing blocks 2 which can be tensed onto the printing block cylinder next to each other, as is the case with tensing channels offset by 90° to each other, which are typical nowadays. Purely in principle, only one tensing channel with a tensing and register means which is only one side wide can also be provided for each of the printing blocks 2 which can be tensed on the printing block cylinder next to each other. However, the advantages of the invention have an ever greater effect with an increasing number of printing blocks 2 which can be suspended next to each other in the same tensing channel. The printing block cylinder can have a circumference which corresponds to the length of a single printing block 2. In this case, the single printing block 2 is suspended in the same tensing channel via both its leading end and trailing end and is held there by means of the tensing and register means. In a cylinder with a greater diameter and a corresponding number of printing blocks 2 over its circumference, only a leading end of a printing block and a trailing end of another printing block are suspended in the same tensing channel.

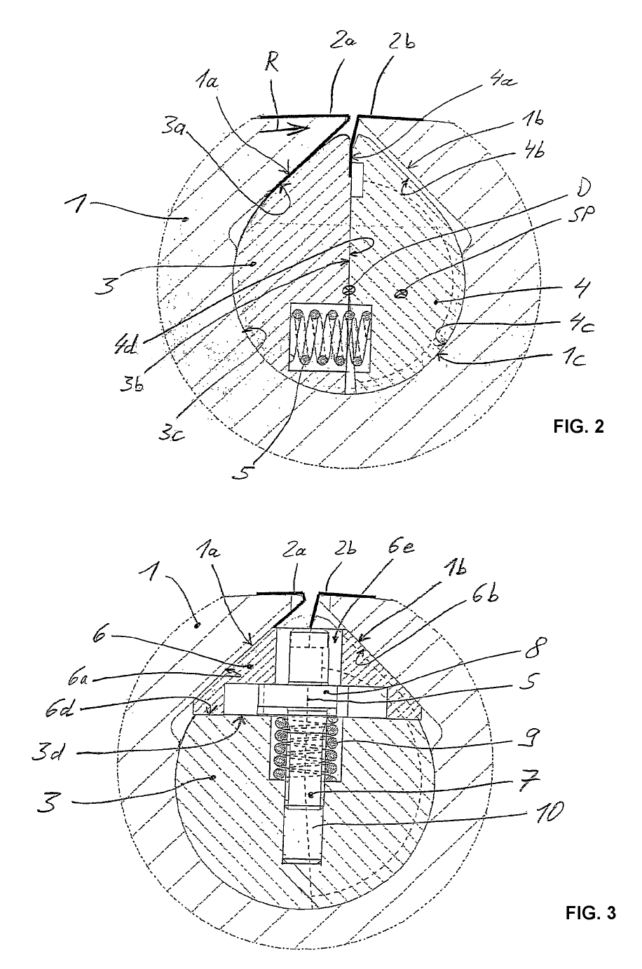

FIG. 2 shows the tensing and register means incorporated into a tensing channel of a printing block cylinder 1. What is shown is the cross-section indicated by A-A in FIG. 1, in which a clamping area of the tensing jaw 3, which is advantageously rigid in its own right, and a clamping area 4a of the tensing counter jaw 4, which is advantageously rigid in its own right, form a clamping gap for a trailing end 2b of a printing block 2. The leading end 2a of the same printing block 2 or of another printing block 2 protrudes into another gap which is defined between a gap area 1a formed by the tensing channel and a gap area 3a of the tensing jaw 3 opposite the gap area 1a in the rotational direction R of the cylinder 1. The gap area 1a is a channel wall formed directly by the cylinder 1 and extending from the leading edge of the channel opening, inclined with respect to a radial extending through the channel opening, onto the rotational axis of the cylinder 1. The gap area 3a is parallel to the gap area 1a. A slight clearance remains between the two gap areas 1a and 3a which is just sufficient to accommodate the acute-angled leading end 2a of the printing block 2. The tensing jaw 3 is fixed in the tensing channel such that it cannot perform any movements transverse to the rotational axis of the cylinder 1. It is also axially fixed. The gap between the gap areas 1a and 3a is therefore invariable, i.e. formed as an invariable, fixed pocket. In principle, however, the tensing jaw 3 does not have to be secured against rotating.

The tensing counter jaw 4 is mounted in the tensing channel such that it can rotate about a rotational axis D. More precisely, it can be tilted about the rotational axis D. For rotationally mounting, the tensing channel forms a mounting area 1c and the tensing counter jaw 4 forms a mounting area 4c, via which it can slide off directly on the mounting area 1c. The mounting areas 1c and 4c are congruently circular-cylindrical. In its rotational movement, the tensing counter jaw 4 slides off on the mounting area 1c without clearance. As can be seen in FIG. 1, each of the tensing counter jaws 4 forms multiple, axially spaced mounting areas 4c as convexly protruding cylinder areas. The mounting areas 4c are formed in the same axial sections as the clamping areas 4a. The mounting area 1c formed by the channel wall, however, extends continuously over the entire length of the tensing channel. The mounting area 1c extends from the base of the channel around the rotational axis D of the tensing counter jaw 4, far enough in the direction of the channel opening that it surrounds a maximally thick cross-section of the tensing counter jaw 4 and thus, in co-operation with the tensing jaw 3, fixes the tensing counter jaw 4 in the radial direction with respect to the rotational axis of the cylinder 1, like a bearing eye.

The tensing jaw 3 and the tensing counter jaw 4 contact each other in the mid-region of the tensing channel, such that the tensing counter jaw 4 comes to rest in the mounting area 1c of the tensing channel without clearance or at least with little clearance. In the example embodiment, the division in the first axial sections of the tensing jaw 3, one of which is shown in FIG. 1, is formed such that the tensing jaw 3 forms a level division area 3b which extends radially with respect to the rotational axis of the cylinder 1 and in the intended extension through the channel opening. The tensing counter jaw 4 likewise forms a division area 4d via which it contacts the division area 3b. The contact between the two division areas 3b and 4d is planar if the end of a printing block is not inserted into the clamping gap formed with the clamping area 4a. If the end 2b of a printing block is inserted, the tensing counter jaw 4 is rotated, against a restoring elasticity force, about the rotational axis D defined by the mounting areas 1c and 4c, thus pivoting the clamping area 4a away from the clamping area of the tensing jaw 3 which helps to form the clamping gap, about the thickness of the end 2b of the printing block.

The division area 4d forms a tilting area for the tensing counter jaw 4, and the division area 3b forms a supporting area on which the tensing counter jaw 4 is supported during its rotational movement, or more precisely tilting movement. The restoring elasticity force generates a clamping force in the clamping gap which clamps the end 2b of the printing block, even when the cylinder 1 is idle. A tensing spring 5—in the example embodiment, a mechanical helical spring which is biased by pressure—charges the tensing counter jaw 4 with the elasticity force. One end of the tensing spring 5 is supported on the tensing jaw 3 and the other end is supported on the tensing counter jaw 4. It is arranged between the tensing jaw 3 and the tensing counter jaw 4 such that its spring force acts on the tensing counter jaw 4 tangentially with respect to the rotational axis of the cylinder 1. It is arranged radially inwards from the rotational axis D of the tensing counter jaw 4 with respect to the rotational axis of the cylinder 1. In the example embodiment, it is accommodated in a tangential bore of the tensing jaw 3 and protrudes into an opposite tangential bore of the tensing counter jaw 4. The tensing spring 5 is also arranged such that its lever arm formed with the rotational axis D is shorter than the lever arm which the clamping area 4a forms with the rotational axis D. The tensing counter jaw 4 is also pressed into sliding contact with the mounting area 1c by the spring force.

With respect to rotationally mounting the tensing counter jaw 4, it should also be noted that a gap remains between the mutually facing division areas 3b and 4d of the tensing jaw 3 and tensing counter jaw 4, said gap extending radially inwards from the rotational axis D such that the clamping area 4a of the tensing counter jaw 4 can pivot away from the tensing jaw 3, against the force of the tensing spring 5, which makes it easier or only then at all possible to insert the end 2b of the printing block into and withdraw it from the clamping gap.

The tensing counter jaw 4 is slightly retracted radially inwards from its clamping area 4a, thus defining the clamping area 4a more exactly.

The centre of gravity SP of the tensing counter jaw 4 is spaced from its rotational axis D. The distance D-SP forms a lever which due to centrifugal forces generates a torque, when the cylinder 1 is rotating, about the rotational axis D which increases with the rotational speed of the cylinder and amplifies the clamping force acting on the end 2b of the printing block in the clamping gap.

The tensing channel widens, symmetrically in and counter to the rotational direction R, from the channel opening formed on the surface of the cylinder, i.e. from the channel edges between which the channel opening is axially enclosed. In the example embodiment, the channel walls extending up to the channel opening—one of which forms the gap area 1a and the other of which forms another gap area 1b—are each inclined at the same, constant angle with respect to a radial onto the rotational axis of the cylinder extending through the channel opening. Gaps for the end of a printing block are thus formed on both sides of the channel opening, namely the invariable gap between the gap areas 1a and 3a already mentioned and, on the other hand, another gap between the gap area 1b and a gap area 4b formed by the tensing counter jaw 4. In this way, if the rotational direction of the cylinder 1 is reversed, the same clamping conditions as for the illustrated rotational direction R are maintained, merely with the difference that, if the rotational direction is reversed, the leading end 2a of the printing block is inserted into the gap between the gap areas 1b and 4b and the trailing end 2b is inserted into the clamping gap between the tensing jaw 3 and the tensing counter jaw 4.

FIG. 3 shows the tensing and register means, incorporated into the tensing channel, in the cross-section B-B through one of the register members 6 as indicated in FIG. 1. The register member 6 forms a register cam which engages with an exact-fit cavity in the leading end 2a of the printing block 2 and, in the register engagement thus established, positions the printing block 2 axially on the printing block cylinder 1 in a positive lock. The register member 6 is centred and channeled in an exact fit between a supporting area 3d in one of the second axial sections of the tensing jaw 3 and the two radially facing channel walls which, in their axial extension, form the gap areas 1a and 1b. The supporting area 3d points tangentially with respect to the rotational axis of the cylinder 1 and runs axially. The other two supporting areas—which, like the gap areas, are indicated by 1a and 1b since they continuously extend them axially—also extend exactly axially.

The register member 6, together with an adjusting member 7, the tensing jaw 3 as a bearing member and—in the example embodiment—a spring 9 as a securing member, already forms one of the register means of the integrated tensing and register means. The adjusting member 7 forms a first joint connection with the tensing jaw 3 and a second joint connection with the register member 6. The first joint connection is a screw joint with a rotational axis S of the joint which points radially onto the rotational axis of the cylinder 1 and extends through the channel opening.

The joint connection with the register member 6 is a cam joint in which the register member 6 forms two guide rails and the adjusting member 7 forms the engagement member which simultaneously slides off on the two guide rails. The two guide rails of the register member 6 point transverse—in the example embodiment, tangentially—with respect to the rotational axis of the cylinder 1. They are formed by two opposite side walls, axially facing each other, of an elongated hole 6c which is recessed in the register member 6 on the supporting counter area 6d which contacts the supporting area 3d. The register member 6 is also provided with a passage 6e through which the adjusting member 7 is accessible via the channel opening, for adjusting the register member 6 by means of an adjusting tool, for example a screwdriver. The radial passage 6e is formed as a simple bore.

The adjusting member 7 is a bolt. It comprises a shaft which is screwed into a radial bore 10 of the tensing jaw 3 and thus forms the screw joint. It also comprises an eccentric section 8 with which the adjusting member 7 forms the cam joint with the register member 6. Radially opposite the shaft, another shaft projects from the eccentric section 8 and extends up to the radially outer periphery of the register member 6, where it forms a shape, for example a slit, a polygonal indentation or a projecting polygonal stub which enables the adjusting tool to be engaged in a positive lock. The eccentric section 8 is accommodated in the elongated hole 6c. The spring 9, the spring force of which presses the threads of the tensing jaw 3 and adjusting member 7 which form the screw joint against each other in every possible rotational position of the adjusting member 7, ensures—as the securing member—that the adjusting member 7 is attached to the tensing jaw 3 in a joint without clearance.

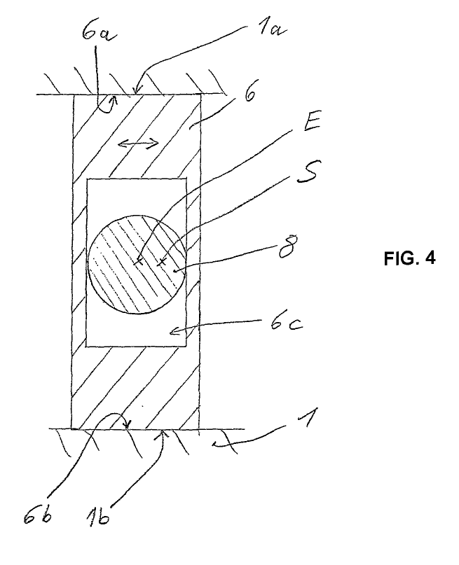

FIG. 4 shows the second joint formed between the register member 6 and the adjusting member 7, i.e. its eccentric section 8, in a section which is perpendicular to the joint axis B of the first joint and points tangentially with respect to the rotational axis of the cylinder 1. The eccentric section 8 is circular-cylindrical about the joint axis S, i.e. the rotational axis of the adjusting member 7. A central longitudinal axis E of the eccentric section 8 is eccentric, i.e. spaced in parallel, with respect to the joint axis S. The two longitudinal sides of the elongated hole 6c, facing each other axially, each form a planar guide rail on which the eccentric section 8 slides off during a rotational movement about the joint axis S. The two gap areas 1a and 1b of the tensing channel axially and linearly guide the register member 6. The diameter of the eccentric section 8 and the axial distance between the two guide rails of the elongated hole 6c are produced to a narrow sliding fit, such that for practical purposes, the fit between the register member 6 and the eccentric section 8 may be said to be without clearance. By rotating the eccentric section 8 about the joint axis S, the register member 6 can be adjusted out of an axial mid-position in the axial direction by double the eccentricity, i.e. by twice the distance between the parallel axes S and E. The spring force of the spring 9 ensures that the adjusting member 7 cannot be adjusted by itself during operations. As applicable, the register member 6 is axially secured in the axial position set, by another securing measure.

1. A printing cylinder, comprising:
a) a cylinder body defining at least one tensing channel for tensing with at least one printing block;
b) a tensing jaw arranged in the tensing channel; and
c) a tensing counter jaw which is arranged next to the tensing jaw in the tensing channel and is tiltable about a rotational axis relative to the tensing jaw and the cylinder body, and comprises a tilting area on an outer circumferential area;
d) wherein the tensing jaw and the tensing counter jaw define at least a portion of a gap, into which one end of the at least one printing block can be inserted; and
e) wherein the tensing counter jaw is supported during a tilting movement via its tilting area on a supporting area formed in the tensing channel.

2. The printing cylinder according to claim 1, wherein an outer circumferential area of the tensing jaw forms the supporting area.

3. The printing cylinder according to claim 1, wherein the tensing counter jaw is supported on a rear side of its outer circumferential area facing away from the tilting area such that it can rotationally slide on a rotational mounting area which is open towards the tensing counter jaw.

4. The printing cylinder according to claim 3, wherein the rotational mounting area surrounds the tensing counter jaw beyond an imaginary circle through the rotational axis of the tensing counter jaw and drawn about the rotational axis of the printing cylinder, and thus supports it against a centrifugal force acting on the tensing counter jaw when the printing cylinder rotates.

5. The printing cylinder according to claim 3, wherein a wall of the tensing channel forms the rotational mounting area.

6. The printing cylinder according to claim 1, wherein the tensing counter jaw exhibits the shape of a longitudinally divided shaft and a longitudinally extending division area forms the tilting area.

7. The printing cylinder according to claim 1, further comprising a spring means which charges the tensing counter jaw with a spring force which acts at least substantially tangentially with respect to the rotational axis of the printing cylinder.

8. The printing cylinder according to claim 1, wherein the tensing jaw and the tensing counter jaw form the gap with each other, or at least one of the jaws forms the gap with a facing wall (1a, 1b) of the tensing channel formed by the cylinder body or an insert fixedly connected to the cylinder body.

9. The printing cylinder according to claim 1, wherein a centre of gravity of the tensing counter jaw is spaced from the rotational axis of the tensing counter jaw and a lever is thus obtained, via which, when the printing cylinder rotates, the centrifugal force of the tensing counter jaw generates a clamping force for the at least one printing block in a clamping gap.

10. The printing cylinder according to claim 1, wherein at least one of the tensing jaw and the tensing counter jaw defines a fixed pocket with a facing wall (1a, 1b) of the tensing channel, into which an angled end of the at least one printing block can be inserted.

11. The printing cylinder according to claim 1, wherein a second tensing jaw is arranged in the tensing channel axially next to the tensing jaw, and a second tensing counter jaw is arranged in the same way axially next to the tensing counter jaw, in order to clamp one end of another printing block.

12. The printing cylinder according to claim 1, wherein the tensing jaw and the tensing counter jaw can be inserted into and withdrawn from the tensing channel as a pre-joined unit on an end-facing side of the cylinder body, and wherein a spring means is arranged between the tensing jaw and the tensing counter jaw when the unit is pre-joined.

13. The printing cylinder according to claim 1, further comprising a register means arranged in the tensing channel comprising an axially adjustable register member for setting a side register of the at least one printing block.

14. The printing cylinder according to claim 13, wherein the register means comprises an adjusting member which is movably connected in a first joint to the tensing jaw and is movably connected in a second joint to the register member, wherein the second joint converts a movement of the adjusting member in the first joint into the axial movement of the register member.

15. The printing cylinder according to claim 14, wherein the adjusting member is rotatable in the first joint relative to the tensing jaw about a rotational axis (B) and forms an eccentric section with respect to this rotational axis (B), which slides off on a guide rail formed by register member in the second joint.

16. The printing cylinder according to claim 14, wherein the register member and the adjusting member form the register means with the tensing jaw as a bearing member.

17. The printing cylinder according to claim 1, wherein the tensing channel widens, symmetrically clockwise and anti-clockwise, from an opening of the tensing channel radially inwards to both sides of the opening, to drive the printing cylinder.

18. A printing cylinder, comprising:
a) a cylinder body defining at least one tensing channel for tensing with at least one printing block;
b) a tensing jaw arranged in the tensing channel; and
c) a tensing counter jaw which is arranged in the tensing channel and movable relative to the tensing jaw and the cylinder body;
d) wherein the tensing jaw and the tensing counter jaw form a gap with each other or at least one of the jaws forms a gap with a facing wall (1a, 1b) of the tensing channel formed by the cylinder body or an insert fixedly connected to the cylinder body, into which at least one end of the at least one printing block can be inserted.

19. (canceled)

20. The printing cylinder according to claim 18 wherein the tensing jaw forms a fixed pocket with the wall of the tensing channel facing it or with the tensing counter jaw, into which an angled end of the at least one printing block can be inserted.

21. The printing cylinder according to claim 18 wherein the tensing jaw is secured against a movement transverse to a rotational axis of the printing cylinder.

22. The printing cylinder according to claim 18 wherein a spring means is supported on the tensing jaw and charges the tensing counter jaw with a spring force which acts at least substantially tangentially with respect to the rotational axis of the printing cylinder.

23. The printing cylinder according to claim 18 wherein the tensing counter jaw is mounted such that it can rotate about a rotational axis relative to the printing cylinder, and the centre of gravity of the tensing counter jaw is spaced from said rotational axis, thus obtaining a lever via which, when the printing cylinder rotates, the centrifugal force of the tensing counter jaw generates a clamping force in a clamping gap.

24. The printing cylinder according to claim 18 wherein the tensing counter jaw and a wall of the tensing channel form a cylindrical slide mounting area for rotationally mounting the tensing counter jaw about a rotational axis parallel to the rotational axis of the printing cylinder.

25. The printing cylinder according to claim 18 wherein the tensing jaw is one piece and extends over the collective length of multiple tensing counter jaws which are each movably arranged in the tensing channel for separately holding printing blocks.

26. The printing cylinder according to claim 18 wherein the tensing counter jaw defines a fixed pocket with the wall of the tensing channel facing it or with the tensing jaw, into which an angled end of the at least one printing block can be inserted.

27. The printing cylinder according to claim 7 wherein the spring means is supported on the tensing jaw and the tensing counter jaw.

28. The printing cylinder according to claim 11 wherein the tensing jaws are formed as a tensing jaw unit which is one piece, and the tensing counter jaws are arranged each individually rotatable.

29. The printing cylinder according to claim 13 wherein the tensing jaw mounts the register means such that it is axially adjustable.

30. The printing cylinder according to claim 14 wherein the adjusting member is produced in one piece.

31. The printing cylinder according to claim 14 wherein the first joint is a rotary joint or screw joint and the second joint is a cam joint.

32. The printing cylinder according to claim 16 further comprising a securing member for mounting the adjusting member without clearance.
